(19) United States
(12) Patent Application Publication
(10) Pub. No.: US 2019/0093989 A1
(43) Pub. Date: Mar. 28, 2019

(54) Basalt Composite Panel

(71) Applicant: HanUSA TechConsult LLC, Pittsburgh, PA (US)

(72) Inventors: Lotar Hanusa, Pittsburgh, PA (US); Maung Aye Than, Lafayette, IN (US)

(21) Appl. No.: 16/197,445

(22) Filed: Nov. 21, 2018

Related U.S. Application Data
(63) Continuation of application No. 12/762,879, filed on Apr. 19, 2010, now abandoned.
(60) Provisional application No. 61/266,833, filed on Dec. 4, 2009.

(51) Int. Cl. F41H 5/04; B32B 37/20; E04B 1/80; E04B 1/94; B32B 27/04; B32B 19/06; B32B 19/04; B32B 19/02; B32B 37/12

(52) U.S. Cl. CPC F41H 5/0471; B32B 2309/12; E04B 1/80; E04B 1/942; B32B 27/04; B32B 19/06; B32B 19/045; B32B 19/02; B32B 2323/043; B32B 37/1284; B32B 2571/00; B32B 2307/3065; B32B 2307/718; B32B 2309/02; Y10T 428/249921; B32B 2309/105; B32B 2309/04; Y10T 442/3065; Y10T 428/24999; Y10T 428/249985; B32B 37/203

(57) ABSTRACT

A composite panel includes a thermoplastic base of ultra high molecular weight polyethylene, a composite layer including basalt fibers, with the composite layer bonded to the thermoplastic base, and the composite layer including at least two sub-layers of basalt material. Each sub-layer of basalt material is bonded to adjacent sub-layers of basalt material, where each sub-layer of basalt material comprises basalt fabric, and where the composite layer provides a protective fire barrier configured to prevent flame and smoke generation upon application of a 3400° F. flame to the composite layer.

### CROSS REFERENCE TO RELATED APPLICATIONS

This application is a continuation of U.S. application Ser. No. 12/762,879, filed Apr. 19, 2010, which claims the benefit of U.S. Provisional Application No. 61/266,833, filed Dec. 4, 2009, which are each hereby incorporated by reference in their entirety.

### BACKGROUND OF THE INVENTION

### Field of the Invention

The present invention is directed to a composite panel and, more particularly, to a basalt composite panel.

### Description of Related Art

Basalt fabric is known to give some protection from fire exposure. Basalt fabric has been used, for example, in manufacturing protective clothing for fire fighters. Further, high strength ultra high molecular weight polyethylene (UHMWPE) fiber is known to be an effective material for ballistic protection. UHMWPE is sold under the trade names DYNEEMA® and SPECTRA®. One of the limitations of UHMWPE is its low melting point (approximately 142° C.) and ease of catching fire. In particular, once ignited the UHMWPE becomes fuel for fire propagation. Tracer and other military rounds having pyrotechnics have been identified as high risk projectiles for initiating fire. Thus, UHMWPE is susceptible to burning when hit by incendiary rounds or tracer rounds.

U.S. Pat. No. 7,001,857 to Degroote discloses a basalt containing fabric and is hereby incorporated by reference in its entirety.

### SUMMARY OF THE INVENTION

In one embodiment, a composite panel includes a thermoplastic base and a basalt fiber-based composite layer attached to the thermoplastic base. The basalt fiber-based composite layer includes at least two sub-layers of basalt material with each sub-layer of basalt material being bonded to adjacent sub-layers of basalt material. The basalt fiber-based composite layer provides a protective fire barrier.

The basalt fiber-based composite layer may be attached to the thermoplastic base via a film adhesive. The film adhesive may be a polyester adhesive film or an ethylene vinyl acetate adhesive film. The basalt fiber-based composite layer may also be attached to the thermoplastic base via a water-based adhesive. Each sub-layer of basalt material may be bonded to adjacent sub-layers of basalt material via a film adhesive or a water-based adhesive. The basalt fiber-based composite layer may further comprise at least one of polypropylene and fiberglass. A plurality of ultra high molecular weight polyethylene fabric layers may define the thermoplastic base and the basalt material may comprise a fabric of woven fibers of basalt in the range of about 9 to 20 microns. The thermoplastic base may have a melting point of less than 500° F.

In a further embodiment, a composite panel includes a foam base and a basalt fiber-based composite layer attached to the foam base. The basalt fiber-based composite layer includes at least two sub-layers of basalt material with each sub-layer of basalt material being bonded to adjacent sub-layers of basalt material. The basalt fiber-based composite layer provides a protective fire barrier.

The basalt fiber-based composite layer may be attached to the foam base via a film adhesive. The film adhesive may be a polyester adhesive film or an ethylene vinyl acetate adhesive film. The basalt fiber-based composite layer may be attached to the foam base via a water-based adhesive. The foam base may comprise rigid polyurethane foam.

In another embodiment, a method of forming a composite panel includes: bonding at least two sub-layers of basalt material to form a basalt fiber-based composite layer; bonding a plurality of ultra high molecular weight polyethylene fabric layers to form a thermoplastic base; and attaching the basalt fiber-based composite layer to the thermoplastic base such that the basalt fiber-based composite layer provides a protective fire barrier.

The basalt fiber-based composite layer may be attached to the thermoplastic base via a film adhesive. The film adhesive may be a polyester adhesive film or an ethylene vinyl acetate adhesive film. The basalt fiber-based composite layer may also be attached to the thermoplastic base via a water-based adhesive. Each sub-layer of basalt material may be bonded to adjacent sub-layers of basalt material via a film adhesive or a water-based adhesive.

### BRIEF DESCRIPTION OF THE DRAWINGS

FIG. 1 is a cross-sectional view of a composite panel according to one embodiment of the present invention;

FIG. 2 is a cross-sectional view of a composite panel according to another embodiment of the present invention;

FIG. 3 is a cross-sectional view of a composite panel according to a further embodiment of the present invention; and

FIG. 4 is a cross-sectional view of a composite panel according to yet another embodiment of the present invention.

### DETAILED DESCRIPTION

For purposes of the description hereinafter, spatial orientation terms, if used, shall relate to the referenced embodiment as it is oriented in the accompanying drawing figure or otherwise described in the following detailed description. However, it is to be understood that the embodiments described hereinafter may assume many alternative variations and embodiments. It is also to be understood that the specific panels illustrated in the accompanying drawing figures and described herein are simply exemplary and should not be considered as limiting.

Referring to FIG. 1, one embodiment of a composite panel 10 includes a basalt fiber-based composite layer 12 and a thermoplastic base 14. The basalt fiber-based composite layer 12 is adhered to, attached to, or formed integrally with the thermoplastic base 14. The term “attached” refers to any arrangement of forming a bond so that the basalt composite layer 12 cannot be easily peeled or separated from the thermoplastic base 14. In particular, the basalt fiber-based composite layer 12 is attached to an outer surface of the base 14. The thermoplastic base 14 may be an organic thermoplastic layer, sheet, or panel with a melting point of less than 500° F.

In a particular non-limiting embodiment, the thermoplastic base 14 is formed from ultra high molecular weight polyethylene (UHMWPE) fiber. The thermoplastic base 14 may be formed from a plurality of UHMWPE fabric layers 14a, 14b consolidated under heat and pressure. The basalt fiber-based composite layer 12 includes at least two sub-layers of basalt material 12a, 12b, which are bonded to each other to define the composite layer 12. The basalt material may be a fabric produced from woven or non-woven fibers of basalt in the range of about 9 to about 20 microns. Further, the composite layer 12 may include materials or fibers in addition to the fibers of basalt. For example, the basalt material may be comingled with other fibers such as polypropylene, fiberglass, or the like. The sub-layers of basalt material 12a, 12b may be bonded to each other, and the composite layer 12 may be bonded to the thermoplastic base 14, using a film adhesive, a two-component epoxy, a water-based adhesive, or any other suitable adhesives.

Examples of suitable film adhesives include the polyester adhesive films (PAF series) and the ethylene vinyl acetate adhesive films (EAF series), which are commercially available from Adhesive Films, Inc. More specifically, the PAF 110 and PAF 130 polyester adhesive films and the EAF 220 and EAF 230 ethylene vinyl acetate adhesive films from Adhesive Films, Inc. were found to be suitable. An example of a suitable water-based adhesive is the DS 7000 series adhesive from Collano Adhesives in Switzerland.

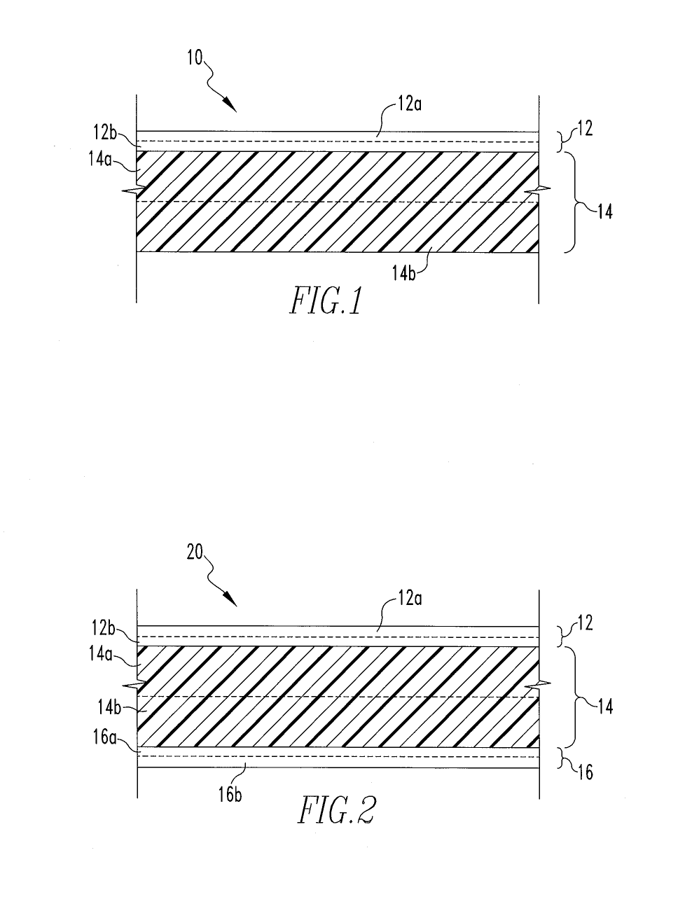

Referring to FIG. 2, a further non-limiting embodiment of a composite panel 20 is disclosed. Like reference numerals are used for like elements. The composite panel 20 of the present embodiment is similar to the composite panel 10 described above and shown in FIG. 1, except that the panel 20 includes an additional basalt fiber-based composite layer 16 positioned opposite the other basalt fiber-based composite layer 12. The additional basalt fiber-based composite layer 16 also includes at least two sub-layers of basalt material 16a, 16b, which are bonded to each other to define the composite layer 16. The thermoplastic base 14 is sandwiched between the two basalt fiber-based composite layers 12, 16. The basalt fiber-based composite layers 12, 16 may be joined to the thermoplastic base 14 in the same manner described above in connection with the panel 10 shown in FIG. 1.

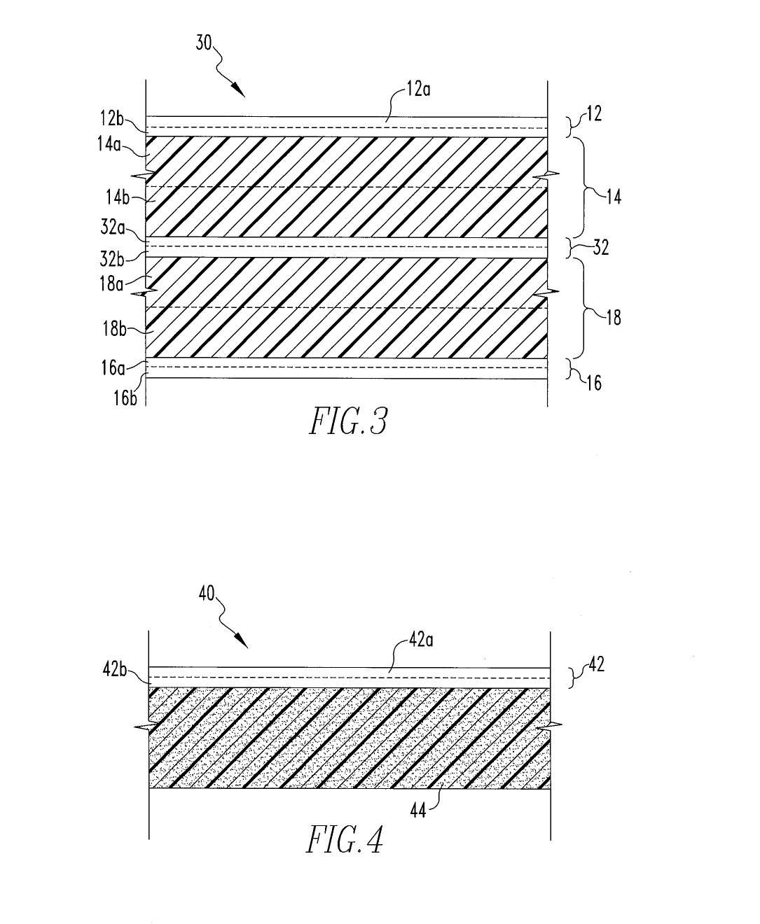

Referring to FIG. 3, another non-limiting embodiment of a composite panel 30 is disclosed. Like reference numerals are used for like elements. The composite panel 30 of the present embodiment includes two thermoplastic bases 14, 18, two basalt fiber-based composite layers 12, 16, and an intermediate basalt fiber-based composite layer 32 provided between the thermoplastic bases 14, 18. As with thermoplastic base 14, the thermoplastic base 18 may be formed from a plurality of UHMWPE fabric layers 18a, 18b consolidated under heat and pressure. The thermoplastic bases 14, 18 are joined together with the intermediate basalt fiber-based composite layer 32 provided between the bases 14, 18. The intermediate basalt fiber-based composite layer 32 includes two sub-layers of basalt material 32a, 32b bonded to each other to define the composite layer 32. The basalt fiber-based composite layers 12, 16 are provided on each side of the panel 30 such that the thermoplastic bases 14, 18 and intermediate basalt fiber-based composite layer 32 are sandwiched between the basalt fiber-based composite layers 12, 16. The intermediate basalt fiber-based composite layer 32 may be attached to, bonded to, or integrally formed with the thermoplastic bases 14, and the basalt fiber-based composite layers 12, 16 may be attached to, bonded to, or integrally formed with the respective thermoplastic bases 14, 18. A suitable adhesive (as described above with respect to the panel 10 shown in FIG. 1) may be used. As described above, the basalt fiber-based composite layer 12 includes at least two sub-layers of basalt material 12a, 12b, which are bonded to each other to define the composite layer 12. Similarly, the basalt fiber-based composite layer 16 includes at least two sub-layers of basalt material 16a, 16b, which are bonded to each other to define the composite layer 16.

Referring to FIG. 4, yet another embodiment of a composite panel 40 includes a basalt fiber-based composite layer 42 and a foam base 44. The basalt fiber-based composite layer 42 is similar to the layer 12 described above. The basalt fiber-based composite layer 42 is adhered to, attached to, or formed integrally with the foam base 44. The term attached refers to any arrangement of forming a bond so that the basalt fiber-based composite layer 42 cannot be easily peeled or separated from the foam base 44. In a particular non-limiting embodiment, the foam base 44 is a rigid polyurethane foam having a nominal density of 2 lbs/cu. ft. Although not shown, the foam base 44 may include two more layers of foam attached to each other to form the base 44. The basalt fiber-based composite layer 42 includes at least two sub-layers of basalt material 42a, 42b, which are bonded to each other to define the composite layer 42. As discussed above, the basalt material may be a fabric produced from woven or non-woven fibers of basalt in the range of about 9 to about 20 microns. Further, the composite layer 42 may include materials or fibers in addition to the fibers of basalt. For example, the basalt material may be comingled with other fibers such as polypropylene, fiberglass, or the like. The sub-layers of basalt material may be bonded to each other, and the composite layer 42 may be bonded to the foam base 44, using a film adhesive, a two-component epoxy, a water-based adhesive, or any other suitable adhesives. Examples of suitable film adhesives and a suitable water-based adhesive are provided above in connection with the composite panel 10.

### EXAMPLE 1

Five tests were conducted to evaluate the fire resistance of five separate panels. Each of the panels was subjected to a 3400° F. flame from a propane torch.

### First Test

In the first test, a composite panel similar to the panel 10 shown in FIG. 1 and having a basalt fiber-based composite layer and a thermoplastic base was tested. The basalt fiber-based composite layer included four sub-layers of basalt fabric bonded together using a film adhesive. The basalt fabric was a commonly available woven commercial basalt fabric having a thickness of 0.05 cm (0.02 in) and weighing 600 g/sq. m (0.12 lbs/sq. ft). The thickness of the composite layer was 0.08 inches and weighed 0.63 lbs/sq. ft. The basalt fiber-based composite layer was bonded to the thermoplastic base using a film adhesive. The thermoplastic base included multiple layers of UHMWPE fabric, in particular DYNEEMA® fabric, which were consolidated under heat and pressure. The thermoplastic base had a thickness of 0.55 inches and a weight of 2.53 lbs/sq. ft. In bonding the composite layer to the thermoplastic base, the temperature at the surface of the thermoplastic base was kept below the melting point of polyethylene polymers, i.e., 148-152° C. (298-306° F.).

The composite panel was set up vertically as the panel would be in a typical wall configuration. Thermocouples were placed between the basalt fiber-based composite layer and the thermoplastic base, into the core of the thermoplastic base, and in front of the composite panel into the direct flame area. The composite panel was subjected to a 3400° F. flame for 1 minute. Actual measured flame temperatures at the sample surface during the test ranged from 1400-2200° F. Neither flame nor smoke was observed during the flame exposure. The composite layer was discolored over a 4-inch diameter area. After removal of the basalt fiber-based composite layer, the exposed thermoplastic base showed no visible signs of damage such as melting or discoloration outside of the direct flame impingement area. Only the surface of the thermoplastic base (approximately 1 inch diameter area) was affected in the direct flame impingement area. Except for this area of the thermoplastic base, there was no evidence of deterioration such as discoloration or fusing of the polyethylene fibers. Despite the 1400° F. temperature measured in front of the panel, the reading from the thermocouple between the composite layer and the thermoplastic base directly behind the flame only reached 300° F. The core of the thermoplastic base remained relatively cool during the test with a temperature reading of 100° F.

### Second Test

In the second test, a composite panel similar to the panel 10 shown in FIG. 1 and having a basalt fiber-based composite layer and a thermoplastic base was tested. The basalt fiber-based composite layer included four sub-layers of basalt fabric bonded together using a water-based adhesive. The basalt fabric was a commonly available woven commercial basalt fabric having a thickness of 0.05 cm (0.02 in) and weighing 600 g/sq. m (0.12 lbs/sq. ft). The basalt fiber-based composite layer was bonded to the thermoplastic base using a water-based adhesive. The thermoplastic base included multiple layers of UHMWPE fabric, in particular DYNEEMA® fabric, which was consolidated under heat and pressure. The composite panel in this test is similar to the panel of first test, except that the sub-layers of basalt fabric were bonded to each other and the composite layer was bonded to the thermoplastic base using a water-based adhesive. The second test was conducted in the same manner as the first test described above.

The observations and results were similar to the first test. There was no flaming or smoke observed and the composite layer adhered strongly in the actual flame impingement area, which was a 3 inch diameter area. The composite layer showed discoloration in a 5 inch diameter area and became brittle in the flame area. Outside of the direct flame impingement area, no discoloration or damage of the thermoplastic base was observed.

### Third Test

In the third test, a thermoplastic base without a basalt fiber-based composite layer was tested. The thermoplastic base included multiple layers of UHMWPE fabric, in particular DYNEEMA® fabric, which was consolidated under heat and pressure. The thermoplastic base had a thickness of 0.55 inches and a weight of 2.53 lbs/sq. ft. The thermoplastic base was subjected to a 3400° F. flame from a propane torch as in the first and second tests. Within seconds after exposure to the torch, the surface of the thermoplastic base erupted into large amounts of flame and smoke. The torch was removed. The thermoplastic base, however, continued to burn vigorously after removal of the flame. Despite the small size of the thermoplastic base (approximately 6 inches square), considerable smoke was given off, and flaming molten polyethylene dripped from the base. Although the thermoplastic base would have burned for a longer period of time, the flames were extinguished after 2 minutes.

### Fourth Test

In the fourth test, a composite panel similar to the panel 10 shown in FIG. 1 and having a basalt fiber-based composite layer and a thermoplastic base was tested. The basalt fiber-based composite layer included a single layer of basalt fabric. The basalt fabric was a commonly available woven commercial basalt fabric having a thickness of 0.05 cm (0.02 in) and weighing 600 g/sq. m (0.12 lbs/sq. ft). The basalt fiber-based composite layer was bonded to the thermoplastic base using a water-based adhesive. The thermoplastic base included multiple layers of UHMWPE fabric, in particular DYNEEMA® fabric, which were consolidated under heat and pressure. The composite panel in this test is similar to the panel of the first test, except that a single layer of basalt fabric was bonded to the thermoplastic base. The fourth test was conducted in the same manner as the first test described above.

The observations and results from the fourth test were very different from the first test. The panel resisted the flame for approximately 30 seconds. Subsequently, significant flaming and smoke were observed. After a total time period of 50 seconds, the flame from the torch was removed and the panel continued to burn on its own. The flame and smoke continued to increase and had to be extinguished.

### Fifth Test

In the fifth test, a composite panel similar to the panel 10 shown in FIG. 1 and having a basalt fiber-based composite layer and a thermoplastic base was tested. The basalt fiber-based composite layer included a first sub-layer of basalt fabric and a second sub-layer of basalt mat. The first sub-layer of basalt fabric was a commonly available woven commercial basalt fabric having a thickness of 0.03 cm (0.01 in) and weighing 260 g/sq. m (0.054 lbs/sq. ft). The second sub-layer of basalt mat was a commonly available commercial mat weighing 1040 g/sq/m (0.22 lbs/sq. ft). The basalt mat was saturated with a water-based adhesive and consolidated to 2 mm at 100 psi at 250° F. The basalt fiber-based composite layer was bonded to the thermoplastic base and the sub-layers of basalt material were bonded to each other using a thermoplastic adhesive film. The thermoplastic base included multiple layers of UHMWPE fabric, in particular DYNEEMA® fabric, which was consolidated under heat and pressure. The composite panel had a thickness of 0.55 inches and a weight of 2.6 lbs/sq. ft. In bonding the basalt fiber-based composite layer to the thermoplastic base, the temperature at the surface of the thermoplastic base was kept below the melting point of polyethylene polymers, i.e., 148-152° C. (298-306° F.).

The fifth test was conducted in the same manner as the first test described above. The observations and results were similar to the first test. There was no flaming or smoke observed after 1 minute and 15 seconds of exposure to the 3400° F. flame.

In view of the above test results, the basalt fiber-based composite layer can provide protection for thermoplastic bases and, in particular, UHMWPE panels used for protective armor from fire damage such as ignition, fire spread, and smoke development even from a high intensity localized fire source. Some protection from fire was expected from literature discussing the use of a single layer of basalt fabric as per the panel of the fourth test. The test results of the composite panel of the present invention, however, were unexpected and surprising with respect to the extent of the protection of the thermoplastic panel in the direct flame impingement area as well as the observed total lack of flaming or smoke generation.

### EXAMPLE 2

A test was conducted to evaluate the performance of a composite panel subjected to a tracer bullet assault. A composite panel similar to the panel 30 shown in FIG. 3 and having two thermoplastic bases, two basalt fiber-based composite layers, and an intermediate basalt fiber-based composite layer was tested. The intermediate basalt fiber-based composite layer was provided between the two thermoplastic bases and included two sub-layers of basalt fabric bonded together using film adhesive. The basalt fabric used for the intermediate basalt fiber-based composite layer was a commonly available woven commercial basalt fabric weighing 540 g/sq. m. Each of the thermoplastic bases included multiple layers of UHMWPE fabric, in particular DYNEEMA® fabric, which were consolidated under heat and pressure. Each thermoplastic base had a thickness of 0.55 inches and a weight of 2.53 lbs/sq. ft. The intermediate basalt fiber-based composite layer was bonded between the thermoplastic bases using film adhesives. In bonding the intermediate layer to the thermoplastic bases, the temperature at the surface of the thermoplastic bases was kept below the melting point of polyethylene polymers, i.e., 148-152° C. (298-306° F.). The first and second basalt fiber-based composite layers were bonded to respective thermoplastic bases as shown in FIG. 3. The basalt fabric sub-layers forming the basalt fiber-based composite layers was a commonly available woven commercial basalt fabric having a thickness of 0.05 cm (0.02 in) and weighing 600 g/sq. m (0.12 lbs/sq. ft). The thickness of each composite layer was 0.08 inches and weighed 0.63 lbs/sq. ft.

The composite panel was subjected to assault using a .223 caliber tracer bullet. The bullet penetrated the composite panel without going through the opposite side. In particular, the bullet penetrated the first basalt fiber-based composite layer and the first thermoplastic base and was stopped prior to penetrating the second thermoplastic base. No evidence of ignition or smoke was observed. The composite panel was cut so that the stopped bullet could be observed. No visual signs of burning of the thermoplastic bases were apparent.

In view of the above test results, the composite panel as shown in FIG. 3 and described above can provide protection for UHMWPE panels used for protective armor from fire damage caused by projectiles such as tracer bullets and similar incendiary projectiles. Some protection from fire from the tracer round was anticipated. The test results, however, were unexpected with respect to the total lack of flaming or smoke generation.

### EXAMPLE 3

Three tests were conducted to evaluate the fire resistance of three separate panels. Each of the panels was subjected to a 3400° F. flame from a propane torch.

### First Test

In the first test, a composite panel similar to the panel 40 shown in FIG. 4 and having a basalt fiber-based composite layer and a foam base was tested. The basalt fiber-based composite layer included four sub-layers of basalt fabric bonded together using a thermoplastic film. The basalt fabric was a commonly available woven commercial basalt fabric having a thickness of 0.05 cm (0.02 in) and weighing 600 g/sq. m (0.12 lbs/sq. ft). The thickness of the composite layer was 0.08 inches and weighed 0.63 lbs/sq. ft. The basalt fiber-based composite layer was bonded to the foam base using the same thermoplastic film that was used to bond the sub-layers of the basalt fabric. The foam base was a rigid polyurethane foam panel having a thickness of 1 inch and a nominal density of 2 lbs/cu. ft. The rigid polyurethane foam panel was also chemically modified to give an ASTM E-84 Class 1 fire rating, which dictates that the foam has a flame spread of less than 25 and smoke development of less than 450 per the ASTM standard.

The composite panel of the first test was set up vertically as the panel would be in a typical wall configuration. Thermocouples were placed between the basalt fiber-based composite layer and the foam base, into the core of the foam base, and in front of the composite panel into the direct flame area. The composite panel was subjected to a 3400° F. flame. After 50 seconds of exposure to the flame, the basalt fiber-based composite layer started to separate from the foam base resulting in ignition of the foam base. The flame was removed from the composite panel at that time. The separation of the basalt fiber-based composite layer from the foam base allowed the foam to be exposed to air and resulted in ignition of the foam.

### Second Test

In the second test, a composite panel similar to the panel 40 shown in FIG. 4 and having a basalt fiber-based composite layer and a foam base was tested. The basalt fiber-based composite layer included four sub-layers of basalt fabric bonded using a thermoplastic film. The basalt fabric was a commonly available woven commercial basalt fabric having a thickness of 0.05 cm (0.02 in) and weighing 600 g/sq. m (0.12 lbs/sq. ft). The basalt fiber-based composite layer was bonded to the thermoplastic base using a water-based adhesive. The foam base was a rigid polyurethane foam panel having a thickness of 1 inch and a nominal density of 2 lbs/cu. ft as used in the first test of this example. The second test was conducted in the same manner as the first test described above.

Actual measured flame temperatures at the composite panel surface during the test ranged from 2300-2400° F. Only a small amount of smoke was observed during the flame exposure. The composite layer was discolored over a 4-inch diameter area. After removal of the basalt fiber-based composite layer, the exposed foam base showed a localized area (approximately 2 inches in diameter) of char in the direct flame impingement area. Except for this area of the foam base, there was no visual damage as evidenced by the lack of char or discoloration. The thermocouple positioned between the basalt fiber-based composite layer and the foam base directly behind the flame impingement area only reached 700° F. resulting in slight charring.

### Third Test

In the third test, a foam base without a basalt fiber-based composite layer was tested. The foam base was a rigid polyurethane foam panel having a thickness of 1 inch and a nominal density of 2 lbs/cu. ft as used in the first test of this example. The foam base was subjected to a 3400° F. flame from a propane torch as in the first and second tests. Within seconds after exposure to the torch, the surface of the foam base ignited and gave off a noxious dense smoke. The flaming stopped after removal of the torch flame. Even though the rigid polyurethane foam panel used in this test has a certain fire resistance, the exposed surface of the foam will readily ignite and burn.

In view of the above test results, the basalt fiber-based composite layer provides protection for a foam base, particularly a rigid polyurethane foam as used for buildings or other applications, from a high intensity localized fire source. Even though some protection of the foam base from fire by the basalt fiber-based composite layer was anticipated, the extent of protection of the foam base in the direct flame impingement area and the observed lack of flaming was unexpected.

Further, although the basalt fiber-based composite layer was utilized in connection with UHMWPE panels and rigid polyurethane foam panels, the basalt fiber-based composite layer may be used to protect other materials from fire damage, such as other types of polyethylene, other thermoplastics, other foams, and the like.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A composite panel comprising:
a thermoplastic base comprising ultra high molecular weight polyethylene;
a composite layer comprising basalt fibers, the composite layer bonded to the thermoplastic base, the composite layer including at least two sub-layers of basalt material, each sub-layer of basalt material being bonded to adjacent sub-layers of basalt material, wherein each sublayer of basalt material comprises basalt fabric, and wherein the composite layer provides a protective fire barrier configured to prevent flame and smoke generation upon application of a 3400° F. flame to the composite layer.

2. The composite panel of claim 1, wherein an entire surface of the composite layer is bonded to the thermoplastic base via an adhesive film.

3. The composite panel of claim 2, wherein the adhesive film is a polyester adhesive film or an ethylene vinyl acetate adhesive film.

4. The composite panel of claim 1, wherein the composite layer is bonded to the thermoplastic base via a water-based adhesive.

5. The composite panel of claim 1, wherein each sub-layer of basalt material is bonded to adjacent sub-layers of basalt material via an adhesive film or a water-based adhesive.

6. The composite panel of claim 1, wherein the composite layer further comprises at least one of polypropylene and fiberglass.

7. The composite panel of claim 1, wherein each sub-layer of basalt material comprises a fabric of woven fibers of basalt having a diameter in the range of about 9 to 20 microns.

8. The composite panel of claim 7, wherein the composite layer is bonded to the thermoplastic base via an adhesive film or a water-based adhesive.

9. The composite panel of claim 1, wherein the thermoplastic base has a melting point of less than 500° F.

10. The composite panel of claim 8, wherein a combined thickness of the at least two sub-layers of basalt material is at least 0.1 cm.

11. The composite panel of claim 10, wherein the combined thickness of the at least two sub-layers of basalt material is 0.2 cm.

12. The composite panel of claim 10, wherein each of the at least two sub-layers of basalt material has a weight of 600 g/sq. m.

13. The composite panel of claim 1, wherein the at least two sub-layers of basalt material comprises a first sub-layer and a second sub-layer, the first sub-layer comprising basalt fabric, the second sub-layer comprising basalt mat.

14. The composite panel of claim 13, wherein the first sub-layer comprises a fabric of woven fibers of basalt having a diameter in the range of about 9 to 20 microns.

15. The composite panel of claim 14, wherein the second sub-layer has a weight of 1040 g/sq. m.

16. The composite panel of claim 1, wherein the thermoplastic base has a thickness of at least 0.55 inches.

17. The composite panel of claim 1, wherein the thermoplastic base comprises a first thermoplastic base and a second thermoplastic base, an entire surface of the composite layer is bonded to an outer surface of the first thermoplastic base.

18. The composite panel of claim 17, further comprising an intermediate composite layer positioned between the first and second thermoplastic bases, the intermediate composite layer comprising basalt fibers.

19. The composite panel of claim 18, wherein the intermediate composite layer comprises at least two sub-layers of basalt material, each sub-layer of basalt material of the intermediate composite layer being bonded to adjacent sub-layers of basalt material.
